(19) United States
(12) Patent Application Publication
(10) Pub. No.: US 2004/0130262 A1
(43) Pub. Date: Jul. 8, 2004

(54) Electroluminescent display device

(75) Inventor: Kiyoshi Yoneda, Mizuho-shi (JP)

Correspondence Address: MORRISON & FOERSTER LLP, 1650 TYSONS BOULEVARD, SUITE 300, MCLEAN, VA, 22102, US

(73) Assignee: Sanyo Electric Co., Ltd., Moriguchi-city (JP)

(21) Appl. No.: 10/674,790

(22) Filed: Oct. 1, 2003

(30) Foreign Application Priority Data
Oct. 1, 2002 (JP) 2002-288501

(51) Int. Cl. H05B 33/00

(52) U.S. Cl. 313/500; 313/505

(57) ABSTRACT

An electroluminescent display device includes a plurality of pixels, an electroluminescent element disposed in each of the pixels, a pixel selecting thin film transistor disposed in each of the pixels and selecting the corresponding pixel in response to a gate signal, and a driving thin film transistor disposed in each of the pixels and supplying an electric current to the corresponding electroluminescent element in response to a display signal supplied through the corresponding pixel selecting thin film transistor. The driving thin film transistor includes a plurality of gates.

### BACKGROUND OF THE INVENTION

1. Field of the Invention

The invention relates to an electroluminescent display device, particularly to an electroluminescent display device which has a pixel selecting thin film transistor and a driving thin film transistor for current-driving of an electroluminescent element in each of pixels.

2. Description of the Related Art

In recent years, electroluminescent (hereafter, referred to as EL) display devices with an El element have been receiving an attention as a new display device substituting for a CRT or an LCD. Particularly, developments are directed to an EL display device having a thin film transistor (hereinafter, referred to as “TFT”) as a switching element driving the EL element.

FIG. 6 shows an equivalent circuit diagram of a pixel in an organic EL display panel. In an actual organic EL display panel, a plurality of the pixels is disposed in a matrix form.

A gate signal line 50 for supplying a gate signal Gn and a drain signal line 60 for supplying a display signal Dm cross each other.

Adjacent a cross section of those signal lines, an organic EL element 70, a driving TFT 80 for driving the organic EL element 70, and a pixel selecting TFT 10 for selecting a pixel are disposed.

A positive power supply voltage PVdd is supplied from a power supply line 90 to a source of the driving TFT 80. A drain of the driving TFT 80 is connected to an anode 71 of the organic EL element 70.

The gate signal line 50 is connected to a gate of the pixel selecting TFT 10, supplying the gate signal Gn thereto. The drain signal line 60 is connected to a drain 10d of the pixel selecting TFT 10, supplying the display signal Dm thereto. A source 10s of the pixel selecting TFT 10 is connected to a gate of the driving TFT 80. The gate signal Gn is outputted from a vertical driving circuit which is not shown. The display signal Dm is outputted from a horizontal driving circuit which is not shown.

The organic EL element 70 includes an anode 71, a cathode 72, and an emitting layer (not shown) formed between the anode 71 and the cathode 72. A negative power supply voltage CV is supplied to the cathode 72.

A storage capacitor Cs is connected to the gate of the driving TFT 80. The storage capacitor Cs is provided for retaining an electric charge corresponding to the display signal Dm for a pixel for one field period.

Operation of the EL display device having the above configuration will be described. When the gate signal Gn turns high level for one horizontal period, the pixel selecting TFT 10 turns on. Then, the display signal Dm is applied to the gate of the driving TFT 80 from the drain signal line 60 through the pixel selecting TFT 10.

Conductance of the driving TFT 80 changes in response to the display signal Dm supplied to the gate, a driving current corresponding to the change is supplied to the organic EL element 70 through the driving TFT 80, and the organic EL element 70 emits light. When the driving TFT 80 is in an off state in response to the display signal Dm supplied to the gate thereof, an electric current does not flow through the driving TFT 80 so that the organic EL element 70 also stops emitting light.

Both active layers of the pixel selecting TFT 10 and the driving TFT 80 are made of a polysilicon layer.

Japanese Patent Application Publication No. 2002-175029 describes one example of a conventional device. In such a conventional EL display device, if light is incident on the driving TFT 80 from outside when the driving TFT 80 is in an off state, a photocurrent is generated and supplied to the organic EL element 70 as a leakage current. This makes the organic EL element 70 emit light when light emission is not supposed to happen.

Furthermore, in the driving TFT 80 of P-channel type, instability of crystals in a polysilicon layer forming a channel region of the transistor results in a large variation in a threshold value among pixels. As a result, the amount of current flowing to the organic EL element 70 varies among the pixels, causing color irregularity in a display panel.

### SUMMARY OF THE INVENTION

The invention provides an electroluminescent display device that includes a plurality of pixels, an electroluminescent element disposed in each of the pixels, a pixel selecting thin film transistor disposed in each of the pixels and selecting the corresponding pixel in response to a gate signal, and a driving thin film transistor disposed in each of the pixels and supplying an electric current to the corresponding electroluminescent element in response to a display signal supplied through the corresponding pixel selecting thin film transistor. The driving thin film transistor includes a plurality of gates.

The invention also provides an electroluminescent display device that includes a plurality of pixels, an electroluminescent element disposed in each of the pixels, a pixel selecting thin film transistor disposed in each of the pixels and selecting the corresponding pixel in response to a gate signal, and a driving thin film transistor including a set of transistors connected in series. The driving thin film transistor are disposed in each of the pixels and supplies an electric current to the corresponding electroluminescent element in response to a display signal supplied through the corresponding pixel selecting thin film transistor.

### BRIEF DESCRIPTION OF THE DRAWINGS

FIG. 1 is a circuit diagram of an electroluminescent display device of a first embodiment of the invention.

FIG. 2 is a plan view of the electroluminescent display device of the first embodiment of the invention.

FIG. 3 is a cross-sectional view of the display device of FIG. 2 along line X-X.

FIG. 4 is a circuit diagram of an electroluminescent display device of a second embodiment of the invention.

FIG. 5 is a plan view of the electroluminescent display device of the second embodiment of the invention.

FIG. 6 is a circuit diagram of a conventioal electroluminescent display device.

### DETAILED DESCRIPTION OF THE INVENTION

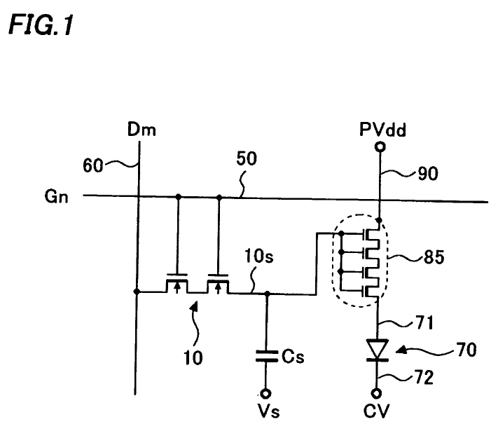

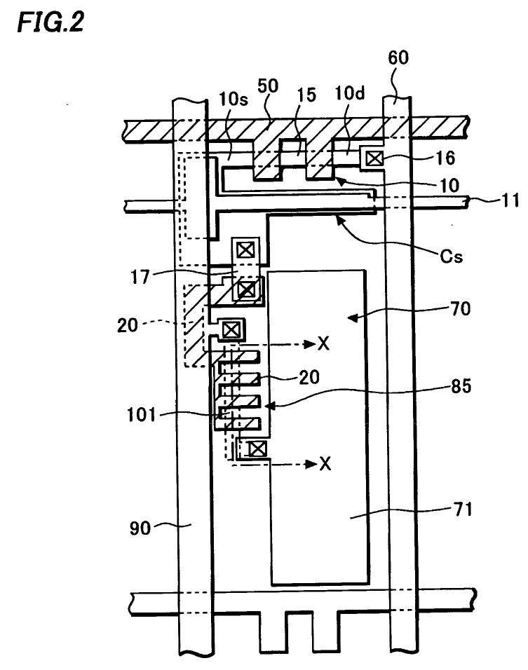

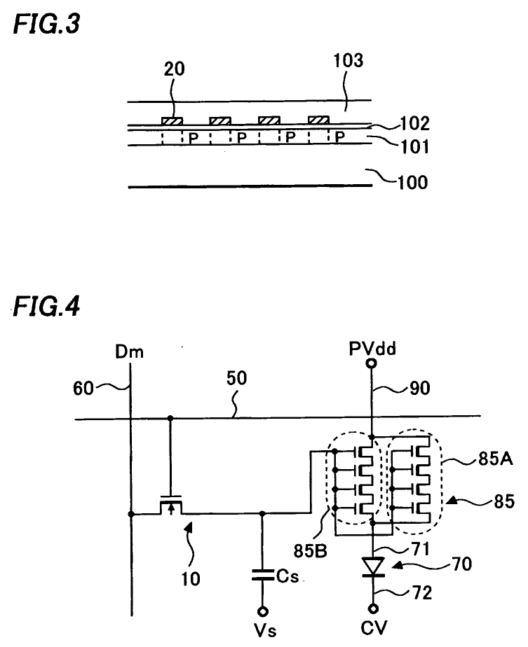

Embodiments of the invention will be described with reference to the drawings in detail. An organic EL display device of a first embodiment of this invention will be described with reference to FIGS. 1, 2, and 3. FIG. 1 is an equivalent circuit diagram of a pixel in an organic EL display panel of the display device. FIG. 2 is a plan view of the pixel. FIG. 3 is a cross-sectional view of the pixel of FIG. 2 along line X-X in FIG. 2. In an actual organic EL display panel, a plurality of the pixels is disposed in a matrix from.

The driving TFT 85 of the organic EL element 70 has a multiple gate structure. That is, an active layer 101 made of a polysilicon layer is disposed on a transparent insulating substrate 100 made of a glass substrate or the like. On the active layer 101, multiple gates 20 are disposed in a comb teeth shape with a gate insulating layer 102 interposed therebetween. On the multiple gates 20, an interlayer insulating layer 103 is formed (FIGS. 2 and 3). A plurality of transistors having a common gate is connected in series, as shown in FIG. 1. This common gate is connected to a source 10s of the pixel selecting TFT 10 (FIG. 1).

A pixel configuration will be described in detail hereafter. A gate signal line 50 for supplying a gate signal Gn is disposed in a row direction, and a drain signal line 60 for supplying a display signal Dm is disposed in a column direction. Those lines cross three-dimensionally without contacting each other. The gate signal line 50 is made of a Cr (chromium) layer, a Mo (molybdenum) layer or the like. The drain signal line 60 is made of an aluminum layer or the like and is formed above the gate signal line 50.

The pixel selecting TFT 10 has a double gate structure in which a gate insulating layer (not shown) is formed on an active layer 15 made of a polysilicon layer, and two gates extending from the gate signal line 50 are placed on the gate insulating layer. A drain 10d of the pixel selecting TFT 10 is connected to the drain signal line 60 through the contact 16. The polysilicon layer forming the source 10s of the pixel selecting TFT 10 extends to a storage capacitor region, and overlaps an upper storage capacitor line 11 with a capacitor insulating film interposed therebetween, forming a storage capacitor Cs at this overlapping portion.

The polysilicon layer extending from the source 10s of the pixel selecting TFT 10 is connected to the multiple gates 20 of the driving TFT 85 through aluminum wiring 17. The multiple gates 20 are made of a Cr (chromium) layer or a Mo (molybdenum) layer. The multiple gates 20 are comb teeth shaped and placed on the active layer 101 of the driving TFT 85 with the gate insulating layer interposed therebetween.

A source of the driving TFT 85 is connected to a power supply line 90 supplied with a positive power supply voltage PVdd. A drain of the driving TFT 85 is connected to an anode 71 of the organic EL element 70 through a contact.

Accordingly, in the driving TFT 85 of the organic EL element 70 having a multiple gate structure above, even if light is incident on a channel region of one of the four transistors connected in series and a photocurrent is generated in that transistor, a photocurrent does not flow through the driving TFT 85, unless photocurrents are simultaneously generated in all of other three transistors. As a result, the organic EL element 70 is prevented from emitting light due to the photocurrent, which results in providing to the organic EL element 70 a leakage current, when the driving TFT 85 is in an off state.

Furthermore, since the driving TFT 85 has a multiple gate structure, a channel region which determines a threshold value of the TFT is separated under the four gates. The crystallographic characteristics of the polysilicon forming each of the channels of the four transistors vary to the extent that the threshold value among the four series transistors varies. Since the threshold value of the driving TFT 85 having the multiple gates is the average of the four threshold values of the individual four transistors, the magnitude of the variation in the threshold value among the driving TFTs is smaller than the magnitude among driving TFTs when these driving TFTs each have a single gate.

Accordingly, this configuration provides a solution to a problem that an electric current flowing to the organic EL element 70 varies among the pixels and thus a display panel shows color irregularity. Although the driving TFT 85 includes four series transistors in this embodiment, the number of the series transistors may be increased or decreased depending on a specific design of the display device.

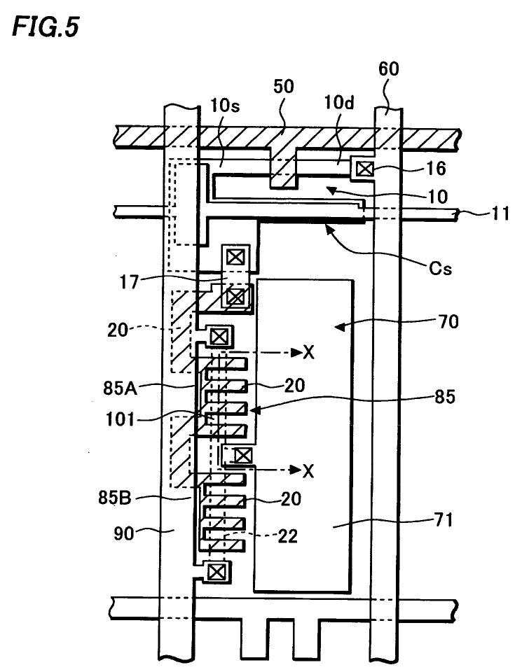

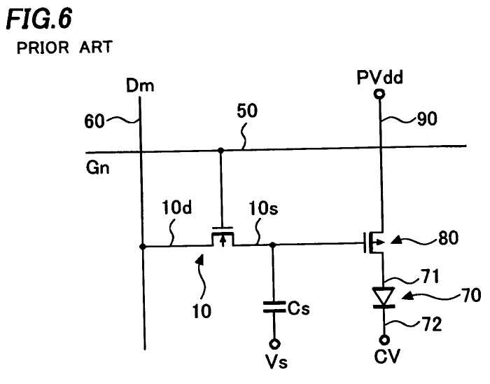

Next, an EL display device of a second embodiment of this invention will be described with reference to FIGS. 4 and 5. FIG. 4 is an equivalent circuit diagram of a pixel in an organic EL display panel. FIG. 5 is a plan view of the pixel of the display device. Note that a cross-section of the pixel of FIG. 5 along line X-X is the same as FIG. 3.

In this embodiment, the driving TFT 85 includes two transistors connected in parallel. That is, the driving TFT 85 includes two parallel transistors 85A and 85B which are connected to a drain, a source and a gate, which are shared by the two parallel transistors 85A, 85B. Each of the parallel transistors 85A, 85B includes the multiple gates 20, which have substantially the same structure as those of the first embodiment.

Each of the parallel transistors 85A and 85B includes four series transistors which are connected in series in a source-drain direction. The common source of the parallel transistors 85A and 85B is connected to the power supply line 90 supplied with a positive power supply voltage PVdd through a contact. The common drain of the parallel transistors 85A and 85B is connected to the anode 71 of the organic EL element 70 through a contact.

Thus, the driving TFT 85 of this embodiment which includes the parallel transistors 85A and 85B provides an advantage that the operation is not affected even if one of the transistors is defective. Although each of the parallel transistors 85A and 85B has the four series transistors in this embodiment, the number of the series transistors may be increased or decreased as appropriate.

Although the pixel selecting TFT 10 has a double gate structure in the first embodiment, a single gate structure may be employed for the pixel selecting transistor in this embodiment.

What is claimed is:

1. An electroluminescent display device, comprising:
a plurality of pixels;
an electroluminescent element disposed in each of the pixels;
a pixel selecting thin film transistor disposed in each of the pixels and selecting the corresponding pixel in response to a gate signal; and
a driving thin film transistor disposed in each of the pixels and supplying an electric current to the corresponding electroluminescent element in response to a display signal supplied through the corresponding pixel selecting thin film transistor, the driving thin film transistor comprising a plurality of gates.

2. The electroluminescent display device of claim 1, wherein the pixel selecting thin film transistor is configured to have only one gate.

3 The electroluminescent display device of claim 1, wherein a total number of gates of the pixel selecting thin film transistor is smaller than a total number of the gates of the driving thin film transistor.

4. The electroluminescent display device of claim 1, wherein the driving thin film transistor comprises a plurality of transistors connected in parallel.

5. An electroluminescent display device, comprising:
a plurality of pixels;
an electroluminescent element disposed in each of the pixels;
a pixel selecting thin film transistor disposed in each of the pixels and selecting the corresponding pixel in response to a gate signal; and
a driving thin film transistor comprising a set of transistors connected in series, the driving thin film transistor being disposed in each of the pixels and supplying an electric current to the corresponding electroluminescent element in response to a display signal supplied through the corresponding pixel selecting thin film transistor.

6. The electroluminescent display device of claim 5, wherein the driving thin film transistor further comprises an additional set of transistors connected in series, and the two sets of the transistors connected in series are connected in parallel.
